(19) United States
(12) Patent Application Publication
(10) Pub. No.: US 2007/0023521 A1
(43) Pub. Date: Feb. 1, 2007

(54) Apparatus and method for security tag detection

(76) Inventors: Chester Wildey, Euless, TX (US); Amber Ansari, Dallas, TX (US); Patrick Kindell, The Colony, TX (US); Jeremy Horvath, Dallas, TX (US); Jim Rittenburg, Perkasie, PA (US); Paul Cronin, Allen, TX (US)

Correspondence Address: FISH & RICHARDSON P.C., P.O BOX 1022, Minneapolis, MN, 55440-1022, US

(21) Appl. No.: 11/192,902

(22) Filed: Jul. 29, 2005

(51) Int. Cl. G06K 7/10; G06K 19/06

(52) U.S. Cl. 235/454; 235/491

(57) ABSTRACT

The present invention relates, in general, to the field of securing, prevention of fraud, or theft of products such as pharmaceuticals, cigarettes, alcohol and other high value often counterfeited products. In particular the invention teaches an apparatus and method to encode packaging of the protected goods using a near infrared luminescing compound and detecting the compound through recognition of a characteristic spectral signature of its emission.

### TECHNICAL FIELD OF THE INVENTION

The present invention relates, in general, to the field of securing, prevention of fraud, or theft of products such as pharmaceuticals, cigarettes, alcohol and other high value often counterfeited products. In particular the invention teaches an apparatus and method to encode packaging of the protected goods using a luminescing compound which shifts the wavelength and detecting the compound through recognition of a characteristic signature of its emission.

### BACKGROUND OF THE INVENTION

Prevention of fraud, copying, or theft of packaged goods such as pharmaceuticals, cigarettes and alcohol has been a long-standing problem in society. In addition to prevention of fraud and theft, authentification and verification is a particular problem in the case of controlled substances such as pharmaceuticals. The prior art is replete with many approaches to deter or avoid fraud, copying or theft by placing a visible and/or invisible identification mark on the goods. Prior art identification marks have been placed on the surface of the goods or in covert locations.

For example, U.S. Pat. No. 4,239,261 issued to Richardson discloses a micro-marking label applied to an article. The marker or label is formed from a small, thin plate of generally clear plastic material. The area of the marker is divided into zones into which homogeneous or digital markings are placed in order to designate a specific code to identify the object. A disadvantage of this marker is that it resides on the surface of the article and so can be seen and examined. Also, the marker can be removed or covered in which case it looses its effectiveness.

In many printing applications it is necessary to distinguish an original from a copy or counterfeit item. With modern copying techniques, printed material can be reproduced easily and can be virtually indistinguishable from the original. Various means and methods have been proposed for covertly marking and identifying such items. Typically, inks or paints are used that fluoresce when subjected to an ultraviolet light. For example, U.S. Pat. No. 4,736,425 issued to Jalon discloses a two-step marking method for important documents to prevent forgery and to authenticate them. However, this method is disadvantageous because the mark must be resident on the surface of the document to be effective.

U.S. Pat. No. 3,614,430 issued to Berler discloses a method of electronically retrieving coded information imprinted on a substantially translucent substrate. An ink is used to code the information that fluoresces when exposed to ultraviolet light. The fluorescence is photoelectrically sensed through the translucent substrate. A reader device then interprets the coded information. A disadvantage is that the coded information is printed on the surface of the substrate.

U.S. Pat. No. 5,542,971 issued to Auslander et al. discloses a bar code printed in an upper layer and lower layer. The ink used to print the lower bar code is a regular ink which absorbs in the visible range of the spectra, i.e., between 400 and 700 nanometers. The upper layer bar code is printed using an ink that is invisible to the naked eye. The invisible inks used are based on complexes of rare earth elements such as Eu, Th, Sm, Dy, Lu and various chelating agents to produce chromophore ligands that absorb in the ultraviolet and blue spectra region. The lower bar code is read by a first excitation source emitting a first wavelength and a first sensor and the upper layer bar code is read by a second sensor detecting second excitation source emitting a second wavelength.

U.S. Pat. No. 6,138,913 issued to Cyr discloses an invisible indicia or encoded information imprinted on a substrate having a compound which produces a fluorescence at a wavelength greater than about 650 nm when exposed to near infrared radiation. The information is covered by a layer of material that reflects or absorbs a substantial amount of visible and UV radiation illuminating its surface.

Japanese Patent No. JP-A-3-154187 (published in 1991) discloses that a cover layer, made of infrared transparent and invisible materials can be used to cover a bar code made of an infrared absorber which absorbs infrared rays within the specific wavelength range between about 700 nm and about 1500 nm. However, the bar codes can be easily located by the use of infrared scopes, and can be easily duplicated because the information contained is in the form of a bar code and not in the form of a special signature.

U.S. Pat. No. RE37491 to Itoh discloses an information storage medium including a code storage portion disposed on a base portion which contains an infrared absorber which absorbs substantially only infrared rays within a narrow wavelength band. Product verification for security purposes is made by detecting a first reflectance of a peak absorption wavelength and a second reflectance at a comparison wavelength in comparing the two. A surface layer can also be provided for concealing the code storage portion. However, the protection layer must be transparent to both visible rays and infrared rays.

U.S. Pat. No. 5,083,814 issued to Guinta et al. discloses a method for applying a marking to a vehicle. The method involves a computer network of authorized dealers which are supplied with input and output devices such as computer, monitor and a hand-held marking device. Using specified locations data supplied from a central process unit, the dealer applies to the surface of the automobile a confidential and invisible registration code. A disadvantage of this method is that the mark is placed on the surface of the article and can be seen with a UV light source. Also, recognition of the spectral signature of the mark may not be remotely controlled.

Therefore, there is a need for an invisible marking that can be placed within the packaging of goods which is invisible to the user but can still be tested for authenticity. There is also a need for a covered marking that is protected from being damaged, analyzed or removed but is capable of being read without being copied. There is also a need to locate and detect a marking under one or more layers of packaging or contaminants or at a relatively large distance from the packaging. Additionally there is a need to allow recognition of a signature of a product to be changed remotely through a computer network.

### SUMMARY OF THE INVENTION

In the present invention, improvements to the field of product security and prevention of fraud in respect to goods such as pharmaceuticals, cigarettes, alcohol and other highly valued products is taught. The present invention utilizes the property of luminescence of various compounds to mark products and extremely sensitive optical filters to avoid counterfeiting and generally provide an identifying signature on security tags internal to product packaging or recognizable at great distances.

The following terms should be given the following meanings:

“Luminescence”—The phenomenon of the emission by matter of electromagnetic radiation which for certain wavelengths or restricted regions of the spectrum is in excess of that due to the thermal radiation from the material at the same temperature.

“Fluorescence”—Property of emitting radiation as the result of, and only during, the absorption of radiation from some other source.

“Phosphorescence”—Emission of light which continues after the exciting mechanism has ceased.

“Window of Transmissivity”—A band of radiation that will be transmitted by a group of materials making up an obscurant.

“Laser”—The term laser includes illumination sources of sufficient intensity to drive the detector through the optics provided to get a result. The illumination sources can include broadband sources such as incandescent lamps and flash bulbs; for example, a zeon flash bulb. Narrow band sources are also included such as gas discharge lasers or solid state compound epitaxial lasers. Illumination sources can also include LEDs and/or arrays of LEDs. Illumination sources further include sources of selected wavelength ranges or groups of ranges.

“Signature”—A parameter set.

Luminescence is the property of admitting radiation as a result of excitation of a molecule by absorption of radiation and then de-excitation of that molecule or ion back to its ground electronic state. Luminescent radiation can have a longer wavelength than that of the absorbed radiation resulting in the downshift in frequency in a Stokes manner. The luminescent radiation can also have a shorter wavelength than the exciting radiation resulting in an upshift in frequency in anti-Stokes manner. For example, when irradiated with ultraviolet radiation with wavelengths between 200 and 400 nm, a known luminescent composition will emit visible light in the range of 400 to 700 nm, as disclosed in published application no. US 2005/0042428 A1, incorporated herein by reference. As another example, a known composition containing phosphor allows infrared rays in the range of 700 to 1000 nm to produce emission in the wavelength range of 800 to 1600 nm from the compound as shown in U.S. Pat. No. 5,611,958, incorporated herein by reference.

Measurement of the luminescence, including spectral domain, time domain and frequency domain properties provides an identifying set of parameters which allows for comparative analysis. Such properties are material dependent and are reproducible and adjustable with the addition of dopants to the compositions which provide for patterns and sequences to the set of parameters.

The present invention utilizes these principles in a security system comprised of a luminescent tagging compound with a specific spectral signature and a reader with the ability illuminate the compound and detect the signature even when very faint. The invention further teaches the ability to detect the tagging compound through several layers of packaging, contaminants or at a great distance. The invention further teaches a novel approach to a system of filters to detect the spectral, time and frequency signature of the tagging compound. Security is enhanced by the ability of the reader to be programmed through a computer network to recognize previously defined material signatures and to report test results over that computer network. Security is further enhanced by the ability of the reader to correlate the type and presence of the tagging compound to a visible bar code.

### BRIEF DESCRIPTION OF THE DRAWINGS

For a more complete understanding of the features and advantages of the present invention, reference is now made to the detailed description of the invention along with the accompanying figures in which corresponding numerals in the different figures refer to corresponding parts and in which:

FIG. 1 is a graphic illustration of one embodiment of the exterior and certain mechanical features of the security tag detection apparatus.

FIG. 2 is a block diagram of one embodiment of the electrical architecture of the security tag detection apparatus.

FIG. 3a is a block diagram of an exemplary optical assembly for the laser beam delivery optics and the emission collection optics of the invention.

FIG. 3b is a block diagram of an exemplary optical assembly for the laser beam delivery optics and the emission collection optics of the invention.

FIG. 4a is an illustration of the temporal behavior of the driving current of the laser in an exemplary embodiment of the invention.

FIG. 4b is an illustration of an analysis curve of an exemplary embodiment of the invention.

FIG. 5 is a flow chart of one embodiment of the steps carried out by software resident in the invention to activate the security detection apparatus.

FIG. 6 is a depiction of one embodiment of the steps carried out by software resident in the invention to activate the security detection apparatus.

FIG. 7 is a flow chart of one embodiment of the steps carried out by software resident in the invention to activate the security detection apparatus.

FIG. 8 is a flow chart of one embodiment of the steps carried out by software resident in the invention to activate the security detection apparatus.

FIG. 9 s a block diagram of the communication architecture of one embodiment of the invention.

### DETAILED DESCRIPTION OF THE INVENTION

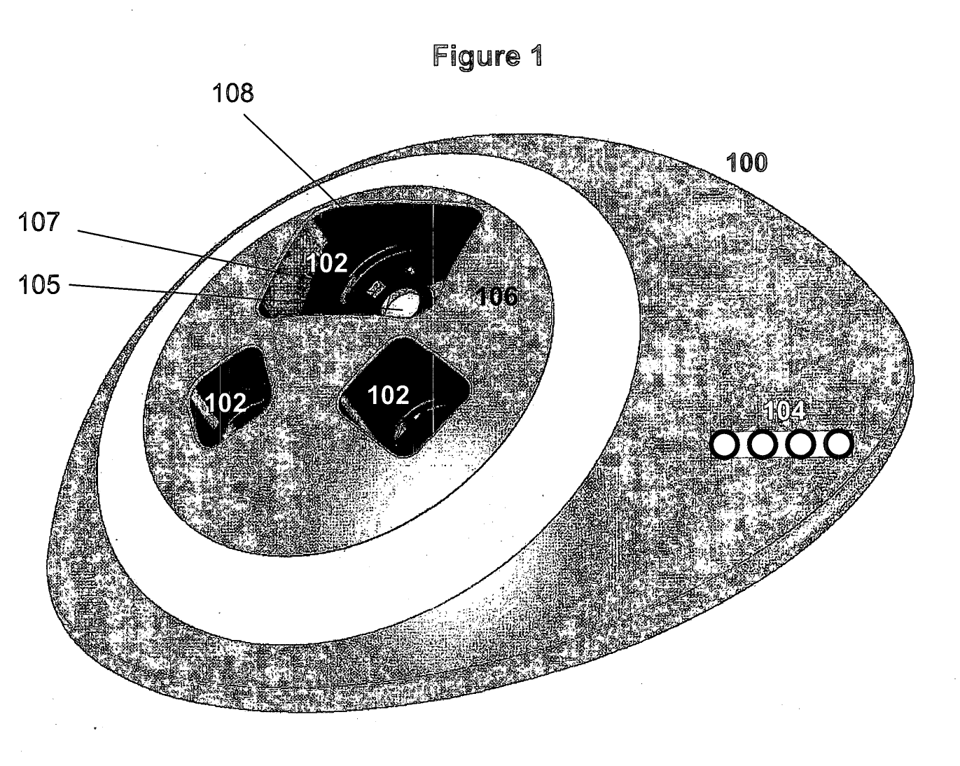

FIG. 1 shows an isometric drawing of one possible embodiment of the security tag detection apparatus 100 for exciting and detecting the optical emission from an encoded package. Other configurations of the external shape of the invention are of course possible. In the preferred embodiment, the package is formed of an opaque material such as a metallic material or a plastic coated with a metallic paint. FIG. 1 shows rotatable head 106, package alignment receptacles 102 and indicator 104. Rotatable head 106 pivots around a central axis which is radially oriented to the device. A plurality of package alignment receptacles 102 are distributed in rotatable head 106 and are shaped to fit a container such as a cap on a bottle. Of course, other shapes are possible and useful depending on the type of package marked. In the preferred embodiment shown in FIG. 1 there are a plurality of package alignment receptacles in order to accommodate packages of different sizes and shapes. In this manner the same optical source and detector may be used for packages of different sizes and shapes.

Package alignment receptacles 102 are positioned so that when rotatable head 106 is turned about its axis, each receptacle may be positioned over hole 105, optical sensors 107 and physical sensors 108. Hole 105 is a physical opening in the device allowing light to pass from the interior of the device to the exterior. In other embodiments a transparent material such as a glass, crystal or ruby window can be included to cover the hole and seal the interior of the device. Optical sensors 108 are electric photo receptors which are positioned to sense the presence of an object in the package alignment receptacle. Physical sensors 108 are mechanical switches also positioned to sense the presence of a physical object. In the preferred embodiment, the optical sensors and the physical sensors cooperate to detect the presence and position of the package to be tested and to prevent unsafe emission from escaping and ensuring that no outside light enters the device through hole 105.

In operation, a package is inserted into a chosen package alignment receptacle 102, the package is then interrogated by a laser through hole 105. In a preferred embodiment of the invention, if a security tagging compound is present in the package, there will be a characteristic emission of light from the compound. The characteristic emission is then analyzed by the invention for a set of recognized parameters. If no compound is present, there will be no characteristic emission. The presence or absence of emission from a security tagging compound and its potential recognition is indicated to the user through indicator 104. In a preferred embodiment indicator 104 is a bank of light emitting diodes and LEDs of different colors.

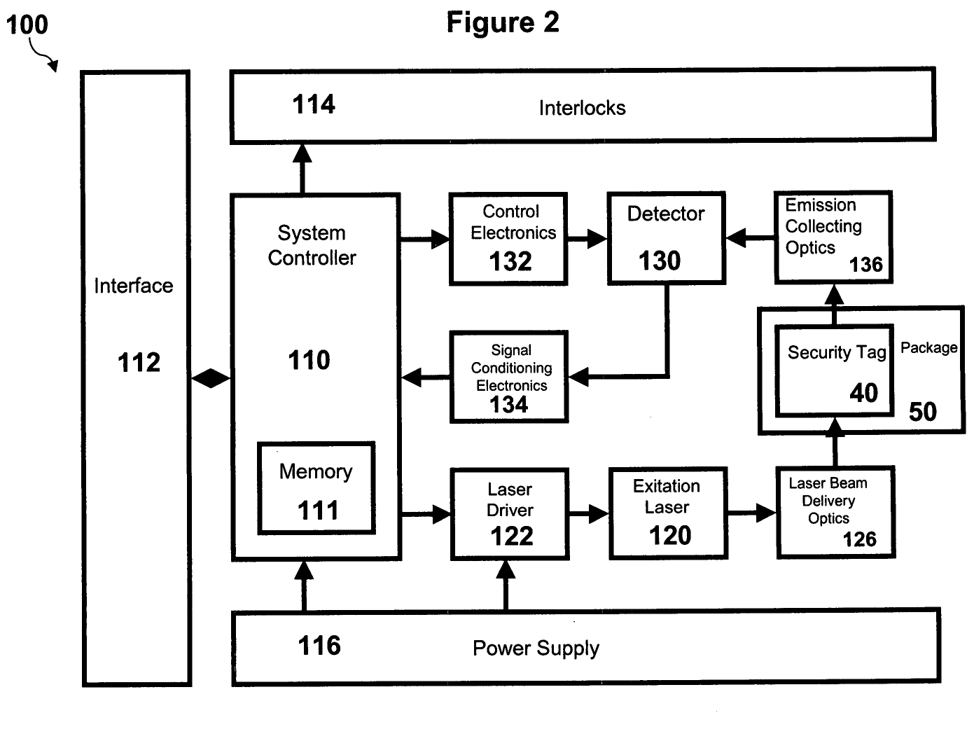

FIG. 2 shows a schematic block diagram of the electronic architecture of one embodiment of the apparatus 100 for exciting and detecting the optical emission from a package encoded with the security tagging compound. As shown in FIG. 2, security tag 40 is deployed on or in package 50. In accordance with the disclosed invention, security tag 40 comprises a chemical compound that emits characteristically when irradiated by a laser, but is otherwise invisible to the unaided eye. The characteristic emission may be a fluorescent emission that is down-shifted in frequency from that of the laser in a Stokes manner. The characteristic emission may also be a phosphorescent emission that is up-shifted in frequency from that of the laser in an anti-Stokes manner.

In a preferred embodiment, the laser radiation and the characteristic emission are in the infrared so as to be invisible to the human eye. In one embodiment the chemical tag comprises an organic dye that emits in the infrared. In an alternate embodiment, the chemical tag comprises a plastic film incorporating a rare earth ion from the list of rare earth ions including La, Ce, Pr, Nd, Pm, Sm, Eu, Gd, Tb, Dy, Ho, Er, Tm, Yb or Lu.

In another preferred embodiment, the laser radiation and characteristic emission are chosen so that both will penetrate layers of different materials used in packaging. For example, modem packaging routinely consists of a plastic exterior, a cardboard or paper wrapper and an interior metallic liner such as aluminum foil. Plastic such as polypropylene is generally transparent to visible, infrared and near infrared light in or around the 900 to 1000 nm wavelength. However, polypropylene is opaque to ultraviolet light. Similarly, paper or cardboard is opaque to visible and ultraviolet light. Therefore, the “window of transmissivity” for this combination of materials is in the infrared.

In the preferred embodiment, the combination of laser wavelength and the emission spectra of the security tag compound are chosen to capitalize on the “window of transmissivity” provided by a combination of the polypropylene and paper packaging. In the preferred embodiment, the excitation and the response of the compound are chosen between 700 m and 1500 nm. Of course, other types and combinations of packaging materials will provide different “windows of transmissivity.”

In the preferred embodiment, the compound containing at least one rare earth ion is applied to the surface of the aluminum foil in a plastic coating. In other preferred embodiments, combinations of various compounds with different fluorescent or phosphorescent emission can be combined to produce different emissions for the same excitation wavelength. In another preferred embodiment, combinations of various frequency laser emissions are employed to elicit different spectral responses from the same or different compounds in security tag 40. It will be readily apparent to one skilled in the art that a variety of other chemicals and chemical compounds may be used to generate characteristic emission in response to laser radiation in accordance with the invention. Generally, excitation radiation and emission in the 250 nm to 2000 nm range is useful in the invention.

The security tag detection apparatus comprises supporting electronic infrastructure including system controller 110, user interface 112, safety interlocks 114 and power supply 116. The security tag detection apparatus 100 further comprises an excitation laser 122, a laser driver, 120, and laser beam delivery optics 126. The security tag detection apparatus further comprises emission detector 130, detector control electronics 132, signal conditioning electronics 134 and emission collecting optics 136.

In a preferred embodiment system controller 110 is a microprocessor, microcontroller or digital computer. System controller 110 includes memory 111. In a preferred embodiment user interface 112 is set of indicator LEDs, for example a set of four color LEDs to indicate the presence of absence of security tag 40 after measurement. As will be obvious to one skilled in the art this embodiment is a low cost interface that provides clear indication to an untrained operator. Alternatively, user interface 112 may be a digital display, for example a CRT display, a liquid crystal display or a field emission display, which would provide a more comprehensive user interface. In this embodiment with a more comprehensive user interface, a touch screen, keyboard or key pad may also be deployed. A USB, wireless, infrared, or wireline serial, parallel or other connection may also be included in user interface 112 to provide a sophisticated user interface connection for trained users or system programmers while maintaining the simpler LED interface for routine use.

Safety interlocks 114 are present to ensure the safety of the operator in the presence of laser radiation. In a preferred embodiment safety interlocks 114 comprise an electronic circuit that prohibits the driving of the laser unless multiple signals are present indicating the proper placement of a package in the package alignment receptacle. In a preferred embodiment, the presence of a package in the package alignment receptacle may be detected by a mechanical switch. In an alternate embodiment, the presence of a package in the package alignment receptacle may be detected optically. In the preferred embodiment, a set of three switches and three optical sensors are placed in the alignment receptacle to assure that the package to be tested is securely seated and that the tag is properly located above hole 105.

The preferred embodiment further includes an optical sensor within the device to check background light “noise”. If the “noise” level is too high, the laser is not allowed to fire.

Power supply 116 supplies electrical power to active components requiring voltage bias or drive current, including, in a preferred embodiment, system controller 110, user interface 112, safety interlocks 114, laser driver 122, detector 130, detector control electronics 132 and signal conditioning electronics 134. In alternate embodiments of the invention, laser beam delivery optics 126, or emission collection optics 136 may also require power in order, for example, to actively scan security tag 40 to record spatially encoded, or patterned information. In a preferred embodiment, power supply 116 may be an ac-dc power supply providing multiple output voltages and currents. Alternatively, for portable applications, power supply 116 may comprise a battery power supply or an inductively coupled power transmission system.

System controller 110 is functionally connected to laser driver 122 which is in turn functionally connected to laser 120. In operation, if safety interlocks 114 indicate the presence of a package in package alignment receptacle 102, then system controller 110 commands laser driver 122 to fire laser 120.

In a preferred embodiment, laser 120 is a semiconductor laser emitting in the near infrared portion of the spectrum, for example, from 800 nm to 1100 nm in accordance with the spectral response of the chemical compound in the security tag. It will be readily apparent to one skilled in the art that InP semiconductor lasers or GaAs semiconductor lasers, or other compound epitaxy may be used for the semiconductor laser. While a diode laser is preferred because of cost, size and power requirements, other lasers such as gas discharge lasers or solid state lasers may also be used in the invention. In an alternate embodiment, more than one laser of different spectral emission can be combined to elicit different responses from the security tag.

Referring to FIG. 2, laser beam delivery optics are positioned to accept the laser beam and direct the beam to security tag 40. In a preferred embodiment, laser beam delivery optics comprise at least one lens and one dichroic mirror in order to focus the laser beam and thereby enhance the emission from security tag 40.

Emission collecting optics 136 are positioned to accept the characteristic emission from security tag 40 and direct it onto detector 130. In a preferred embodiment, emission collecting optics 136 comprise at least one lens in order to focus the characteristic emission and thereby enhance the detected signal from detector 130. Detector 130 detects the characteristic emission and converts the optical signal to an electric signal. In preferred embodiment, the detector is a photomultiplier tube (PMT). In an alternate embodiment, the detector is a solid state semiconductor detector, for example, an avalanche photodiode (APD). In an alternate embodiment, an array of detectors may be used in order to detect the image of a spatially encoded pattern of characteristic emission.

Referring again to FIG. 2, the electrical output of detector 130 may be further optimized using various techniques. For example, system controller 110 may adjust the response or the gain of detector 130 via detector control electronics 132. Detector control electronics 132 in an alternate embodiment includes circuitry to minimize overload recovery time by disabling accelerating voltage on the first several dynodes of the PMT during firing of the laser.

Another optimization technique entails conditioning the detected signal using signal conditioning electronics 134. In order to meet the Nyquist criterion, an anti-aliasing filter acts as a low pass filter to the incoming waveform. The filter of the preferred embodiment filters the waveform at half the sampling frequency or less. In this way, the high frequencies resulting from the PMT are filtered out to prevent false readings and reduce noise. Signal conditioning electronics may further include analog to digital conversion (ADC) and may include a digital signal processor (DSP) such as the TMS 320 from Texas Instruments. The output of the signal conditioning electronics 134 is sent to system controller 110. Further conditioning electronics may include high speed charge sensitive amplifiers for photon counting provided for the photomultiplier tube. In the preferred embodiment the amplifiers have a signal to noise ratio of about 100 dB.

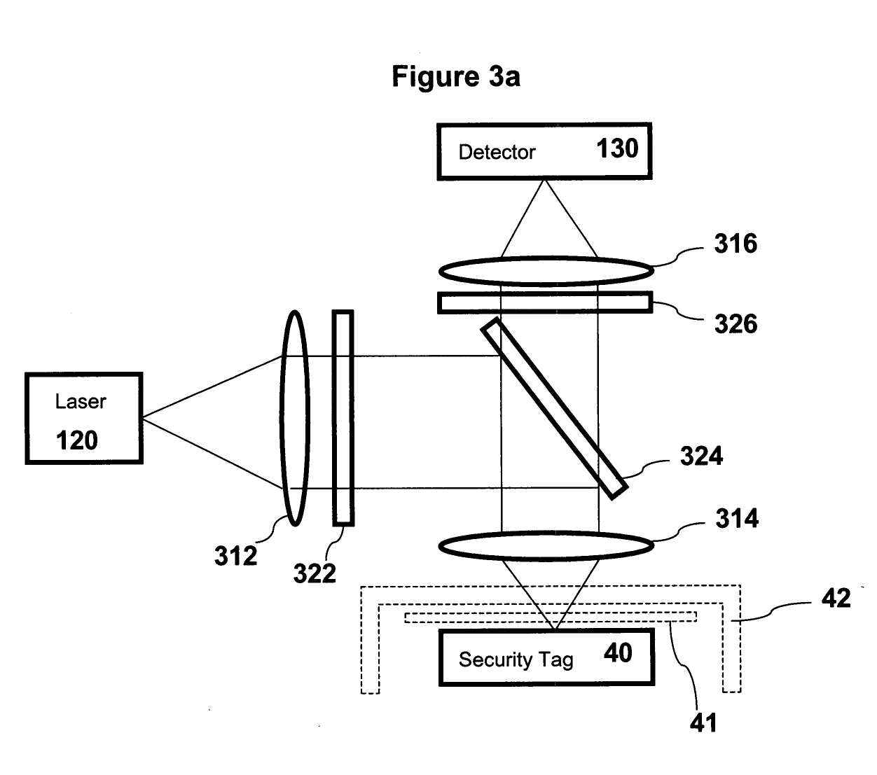

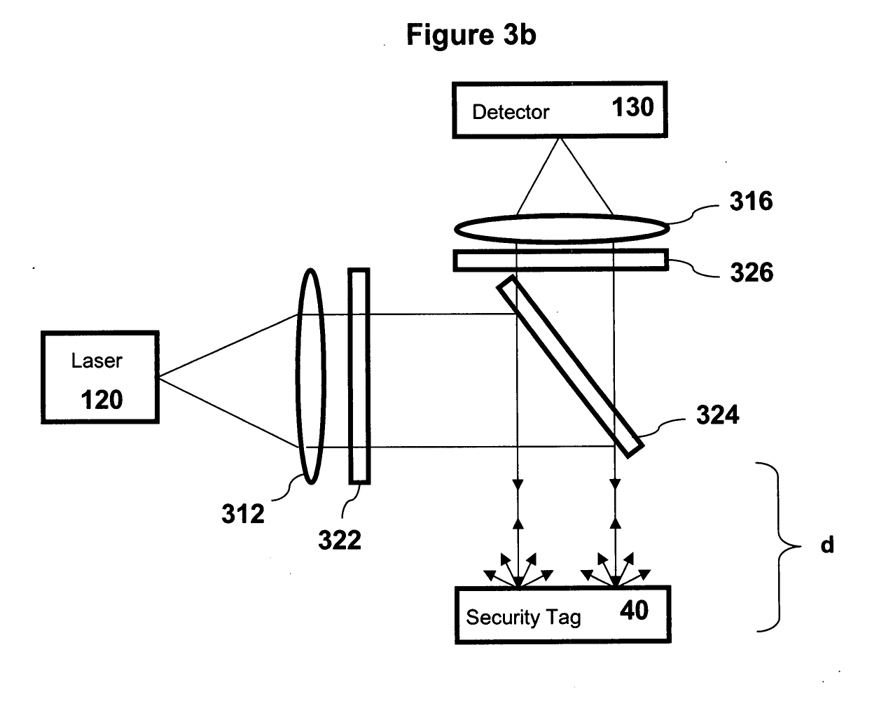

FIG. 3a shows a block diagram of an exemplary optical assembly for the laser beam delivery optics 126 and emission collecting optics 136, including security tag 40, laser 120, and detector 130. Further, shown in FIG. 3a are laser collimator lens 312, focusing lens 314, coupling lens 316, excitation filter 322, emission filter 326, and dichroic mirror 324.

Laser collimator lens 312 acts to collect and collimate the laser radiation emitted from laser 120. In a preferred embodiment laser collimator is an aspheric lens that compensates the astigmatism of the diode laser beam. Bandpass excitation filter 322 allows only a limited band of illumination wavelengths to illuminate the security tag. In the preferred embodiment the bandpass filter is a long pass filter with a rejection ratio close to 10,000:1. Dichroic mirror 324 reflects the laser beam radiation toward security tag 40. The dichroic mirror should have a rejection ratio of about between 5:1 and 100:1. In other embodiments the dichroic mirror may be replaced with a partially silvered mirror. Focusing lens 314 is a focusing lens to concentrate the laser radiation and thereby boost the characteristic signal level emitted from the security tag. In the preferred embodiment the focal point of the lens is at the surface of the security tag. The surface of the security tag may be several layers beneath the surface of the product. The characteristic emission from security tag 40 is collimated by focusing lens 314, and is transmitted through the dichroic mirror. Emission filter 326 further rejects radiation that is not in the spectral band of the characteristic emission. In the preferred embodiment the rejection ratio of the emission filter is close to 10,000:1. Lens 326 focuses the characteristic emission onto detector 130. In the preferred embodiment the characteristic emission is chosen to order to match the preferred collection aperture of detector 130.

In the preferred embodiment, security tag 40 is placed under covering layer 42 and covering layer 41. Covering layer 42 is typically polypropylene plastic. Covering layer 41 is typically of compressed cardboard. In the preferred embodiment, security tag 40 comprises a thin layer of aluminum foil on which is deposited a chemical layer producing a characteristic emission desired. In other embodiments the covering layers can consist of contaminants such as dirt, dust or ice. The combination of collimator lens 312 focusing lens 314 coupling lens 316, bandpass excitation filter 322, emission filter 326, dichroic mirror 324 and signal conditioning electronics as described result in a signal to noise ratio before signal processing of between about 50 db and about 130 db.

It should be noted that the exact arrangement of the optical assembly may be modified to achieve the same functionality. For example, laser collimator lens 312, focusing lens 314, and coupling lens 316, may each comprise multiple optical elements for enhanced performance. Similarly, the position of bandpass excitation filter 322 may be shifted relative to the laser collimator lens 312 if desired. The position of emission filter 326 may be shifted relative to coupling lens 316 if desired.

In an alternate embodiment, the dichroic filter of the optical assembly may be mechanically pivoted and driven to scan the laser beam spatially in order to acquire a characteristic response in a spatial pattern from a patterned security tag. Alternatively, focusing lens 314 and coupling lens 316 may together image the characteristic emission onto a detector array in order to acquire spatial pattern information.

Referring now to FIG. 3b an alternate embodiment of an exemplary optical system for the laser beam delivery objects 126 and the emission collecting optics 136 is shown in a block diagram. In this block diagram dichroic mirror 324 serves to direct delivery of the excitation from laser 120 toward security tag 40. In this embodiment distance “d” between focusing lens 314 and security tag 40 can be a great distance depending on the characteristics of the medium separating the two. For example, in one preferred embodiment where the medium separating dichroic mirror 324 and security tag 40 is dry air distance “d” can be up to about 5,000 feet. In another example where the separating medium is wet air such as encountered during rainy conditions, the distance “d” can be up to about 1,000 feet. It will be recognized by those skilled in the art that the distance is dependent on the signal ratio of the laser excitation to the returning emission from the security tag.

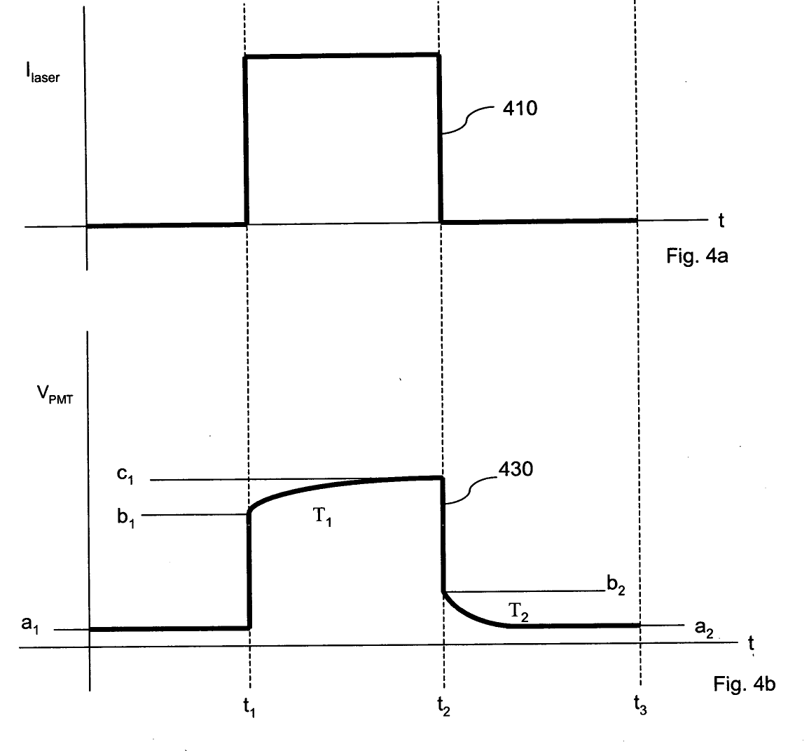

FIG. 4a shows the temporal character of the input current driving the laser radiation of the preferred embodiment of the tagging compound in time traces. Trace 410 is a square wave that approximates the temporal behavior of the input current to the laser. Input current rises quickly starting at time t=t₁, to a constant value and abruptly falls at time t=t₂. It will be understood by those skilled in the art that the input current can be repeated in a train of such pulses in order to repeat the measurement process and thereby acquire sufficient signal to overcome noise.

The time trace shown in FIG. 4b at 430 is the output voltage of the PMT according to the characteristic emission of the security tag. There are four distinct stages to the time trace. The initial level of the background voltage of the PMT is small but non-zero at t=0 to t=t₁ shown as approximately a₁. At t=t₁, there is a rapid linear rise from signal level a₁ to signal level b₁ caused by the onset of illumination after the laser fires. The signal continues to grow, characterized by an exponential with a time constant T₁ ending in a signal level c₁ at t=t₂. At time t=t₂, the end of the laser radiation pulse, to t=t₃, a linear decay lowers the signal level to b_{2.} The signal then takes on an exponential decay with a time constant T₂ ending at a final level a₂ at t=t₃. In this example, t₃≅5T₁, where T₁ is a time constant related to the compound in the security tag.

In the preferred embodiment, the increase of the PMT voltage during the period t₁>t>t₂ is described by the equation:
V_{PMT}=K1−K₁e^{(1-t/T}^{₁}¹⁾+a₁
Similarly, the decrease of the PMT Voltage during the period t₂>t>t₃ is controlled by the equation:
V_{PMT}=K₁e^{-t/T}^{₂}−a₁

Where K₁ is a material constant. In the preferred embodiment, in order to determine the signature of the security tag 40, the values of a₁, b₁, c₁, T₁, K₁, a₂, b₂, and T₂ are repeatedly measured for a train of 16 pulses over a space of about 0.5 seconds. During the period between t=0 and t=t₁, 20 readings are taken at equal time increments before the laser pulse begins. 160 readings are taken between t=t₁ and t=t₂ at equal time intervals during the period that the laser pulse is active. 40 equally timed readings are taken between t=t₂ and t=t₃ during the period that the laser pulse is deactivated, resulting in 220 readings for each pulse. Each similarly timed reading is summed for each of the 16 pulses and a regression analysis is used to determine the best value for each reading. After completion of a regression analysis, values of a₁, b₁, c₁, T₂, K₁, a₂, b₂, and T₂ are determined from the best values of the data. These values form the signature of the tagging compound of the security tag. In an alternate embodiment, any single value or subset of values from the group of a₁, b₁, c₁, T₁, K₁, a₂, b₂, and T₂ can be used as the signature of the compound.

Memory 111, contained in the controller, possesses a lookup table of predetermined values of the spectral signature for one or more formulations of tagging compounds. The values derived from the data are compared to the values in the lookup table within a precision of some multiplier of the standard deviation of each average. In the preferred embodiment, the multiplier is 3. As will be apparent to those of skill in the art, since the standard deviation varies with background noise, a dynamic threshold is established which reduces or eliminates false readings. If the values meet the prescribed criteria, a “match” is declared by the processor and appropriate signals are sent to report the condition to the interface.

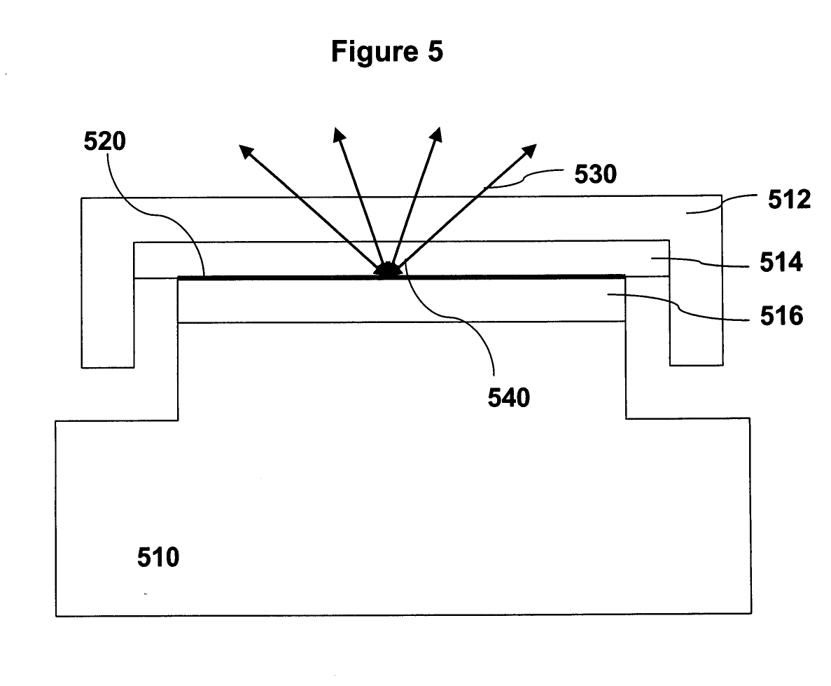

FIG. 5 shows a cross-sectional view of an example of a packaging application and a chemical security tag. This packaging application is typical of bulk packaging of pharmaceutical pills as delivered to pharmacies from manufacturers. Container 510 is closed with plastic cap 512 which typically supports a cardboard liner 514. The package typically includes a hermetic seal 516 comprising foil or polymer bonded to the top of container 510. In a preferred embodiment, hermetic seal 516 comprises the marking surface 520 for security tag 40. Incident laser radiation 530 propagates through plastic cap 512 to excite the tagging compound printed on or included within hermetic seal 516. The characteristic emission 540 propagates back through cardboard liner 514 and plastic cap 512 following the same “light cone” where it is measured by detector 130.

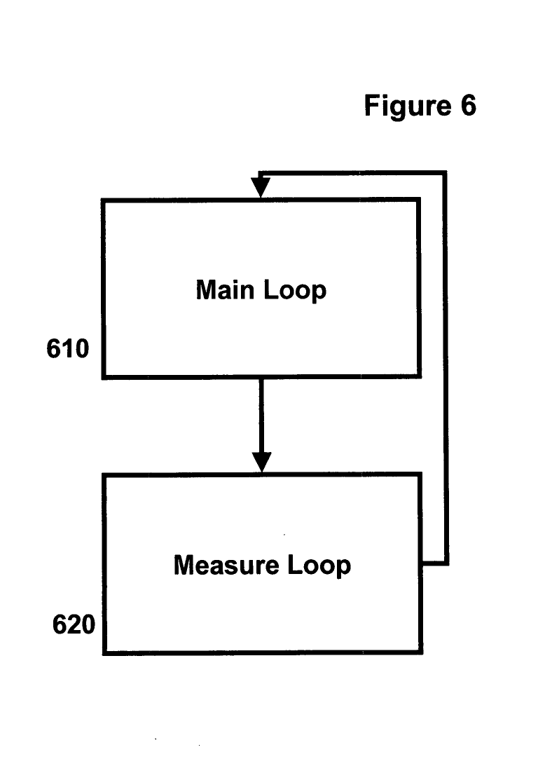

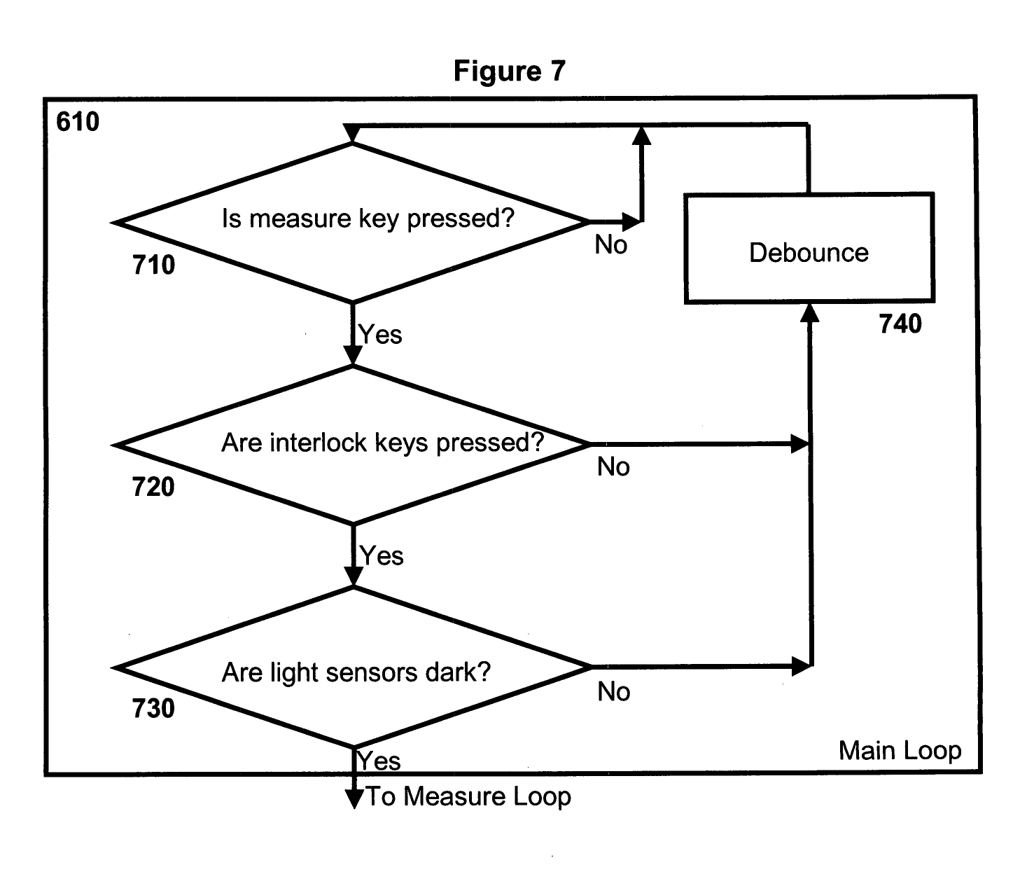

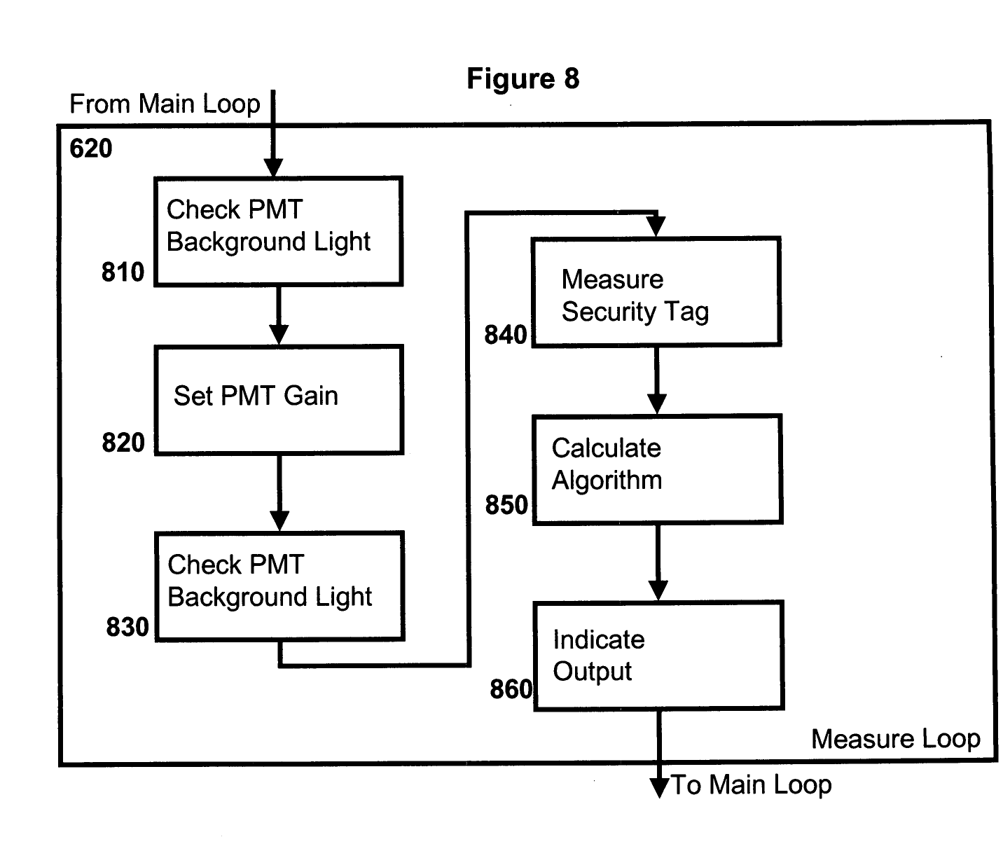

FIGS. 6, 7 and 8 show flow charts illustrating a method of security tag detection in accordance with another aspect of the invention. In FIG. 6 is the overall algorithm for security tag detection programmed into and running in the system controller comprising a Main Loop 610 and a Measure Loop 620. FIG. 7 shows detailed steps comprising Main Loop 610 and in FIG. 8 shows detailed steps comprising Measure Loop 620.

Referring now to FIG. 7, Main Loop 610 comprises Measure Key Status step 710, Interlock Key Status step 720 and Light Sensors Dark Status step 730. If Measure Key Status Step 710 results in a “no” response, then logic loops waiting for a “yes” response. If step 710 results in a “yes” response then logic proceeds to step 720. If Interlock Key Status Step 720 result in a “no” response, then logic proceeds to Debounce step 740. Those skilled in the art will recognize that Debounce step 740 allows the measurement electronics and line voltages to “settle” before proceeding. If step 720 results in a “yes” response then logic proceeds to step 730. If Light Sensors Dark Status step 730 results in a “no” response, then logic proceeds to Debounce step 740. Light Sensors Dark Status step 730 results in a “yes” response, then the logic proceeds from Main Loop 610 to Measure Loop 620.

Referring now to FIG. 8, Measure Loop 620 comprises Check PMT Background Light step 810, Set PMT Gain step 820, Check PMT Background Light step 830, Measure Security Tag step 840, Calculate Algorithm Step 850 and Indicate Output step 860.

Even in total darkness a small anode voltage from the PMT is typically present. In order to set a base line for gain calculation, at step 810 the system controller checks the anode voltage from the PMT.

At PMT gain step 820 the system controller uses the value of PMT voltage derived at step 810 to set the gain of the PMT. In a preferred embodiment, a useful gain control algorithm is utilized to compensate for a temporal hysteresis of the PMT. In this algorithm, the gain is ramped up from the minimum value until optimal signal level is reached. This counterintuitive approach yields a faster acquisition than dithering the gain around the midpoint value.

Once the gain is set, measure loop 620 moves to step 830 where the background light of the PMT is again checked. If the PMT output voltage reading from the PMT at step 830 exceeds that determined in step 810 the system controller returns to step 810 in order to assure that the proper gain is set.

Proceeding to step 840, the system controller transmits appropriate signals to activate the laser and monitor the PMT voltage to gather useful data concerning the signature of the security tag. At step 850 the data is averaged and the calculations for the required coefficients are made. Once calculations for the coefficients are complete comparison is made with the table stored in memory which contains parameters of measured information for one or more types of security tags.

Moving to step 860, if the comparison step results in a “match” this condition is reported at step 860. Similarly if the condition results in a “mismatch” the condition is also reported. The program then exits to main loop 610 to await another test.

The data table stored in memory may contain numerous sets of parameters characterizing the signature of many different types of materials. One skilled in the art will recognize that multiple tests can be run on the same security tag and the results compared with the sets of parameters in the table. In one preferred embodiment of the invention, more than one type of compound is used so that varied security tags can be created. The ability to have different security tags recognized by the invention allows indexing of security tags for different products or for different users.

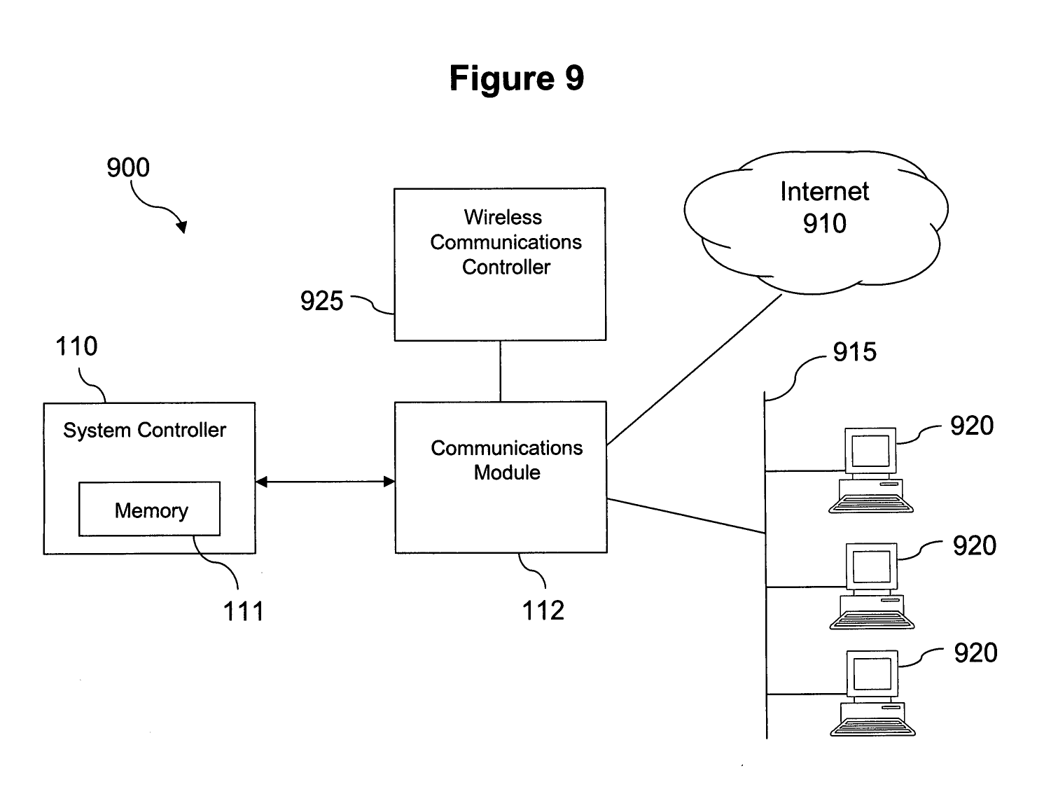

The data loaded into memory 111 can be uploaded from many sources. Referring to FIG. 9, a network architecture 900 is shown including system controller 110 and memory 111. In FIG. 9 system controller 110 is connected to a communications module 112. In the preferred embodiment communications module 112 is a protocol manager capable of supporting an address and receiving and transferring data via TCP/IP protocol. Communications module 112 is further connected to wireless communications controller 925, internet 910 and ethernet 915. In turn ethernet 915 is connected to various network nodes 920. Using this architecture, data tables can be uploaded from any number of sources to memory 111 through communications module 112. Additionally, test responses can be downloaded indicating the results of test from one or more groups of tests procedures carried out by the invention. As a result, additional security is provided because the spectral signature of the security tag can be changed without the knowledge or cooperation of the person conducting the test.

Additionally, wireless communications controller 925 can include a position tracking sensor so that the physical location of the device can be monitored. In one embodiment, the position tracking sensor includes a GPS location device. In other preferred embodiments, the location device includes a dedicated cell phone and use of caller ID information. Moreover, if the device is used on a portable platform, the location can be used to determine the signature that is expected by the system controller to determine a “match”. For example, a first type of pharmaceuticals may be present for a first security tag at a first location and a second type of pharmaceuticals at a second location with a second different security tag. The memory contains a first predetermined signature and a second predetermined signature correlated to different locations. Without reference to or knowledge of the user, GPS data is used by the system controller to choose the correct predetermined signature for each location and recognize the first and second security tags as genuine even though they have different signatures.

In another preferred embodiment, the signature of the security tag can be correlated to an external marking on the package. For example, a bar code is programmed to include information related to the presence or absence and type of compound used in the security tag. In use, the bar code is read by a conventional bar code scanner and the security tag is read by the apparatus, and the results are compared by system controller 110. Security is increased because a counterfeiter cannot consistently detect the correlation of the presence and type of the compound (or absence of the compound) to the bar code and so cannot duplicate the combination.

While this invention has been described in reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

1. A system for detecting a security tag comprising:
a source of radiation;
an emission detector; and,
a radiation and emission filtering means, in the optical path of the source of radiation and the emission detector, to direct radiation from the source of radiation to the security tag and from the security tag to the emission detector and having a signal to noise ratio between about 50 dB and about 130 dB.

2. The system of claim 1 wherein the source of radiation is a laser.

3. The system of claim 1 wherein the source of radiation includes an LED.

4. The system of claim 1 wherein the source of radiation includes an incandescent lamp.

5. The system of claim 1 wherein the laser is constructed from one of the group of GaAₛ and IₙP.

6. The system of claim 2 wherein the laser emits at a wavelength from the group of about 980 nm, about 1550 nm, about 1310 nm and about 2000 nm.

7. The system of claim 1 wherein the source of radiation is pulsed.

8. The system of claim 1 wherein the emission detector is a photomultiplier tube.

9. The system of claim 1 wherein the emission detector is a photodiode.

10. The system of claim 1 wherein the source of radiation and the emission of the security tag are in the range of about 700 nm to about 1500 nm.

11. The system of claim 1 wherein the security tag is one of the group of up converters and down converters.

12. The system of claim 1 wherein the security tag emits luminescence from the group of phosphorescence and fluorescence.

13. The system of claim 1 wherein the security tag contains a rare earth element from the group of elements La, Ce, Pr, Nd, Pm, Sm, Eu, Gd, Tb, Dy, Ho, Er, Tm, Yb or Lu.

14. The system of claim 1 wherein the radiation and emission filter means further directs radiation from the source of radiation to the security tag through an obscurant.

15. The system of claim 14 wherein the obscurant is a plurality of packaging layers.

16. The system of claim 15 wherein the plurality of packaging layers includes a plastic layer and a cellulose layer.

17. The system of claim 15 wherein the plurality of packaging layers includes an ice layer.

18. The system of claim 15 wherein the plurality of packaging layers includes a contaminant layer.

19. The system of claim 14 wherein the obscurant is air.

20. The system of claim 19 wherein the obscurant is between about 1 foot and about 5,000 feet thick.

21. The system of claim 1 wherein the radiation and emission filtering means further comprises:
a laser columnating lens and an excitation bandpass filter in the path of the source of radiation;
a coupling lens and an emission filter in the optical path of the emission detector; and,
a mirror means in the optical path of the source of radiation and the emission detector to reflect incident radiation from the source of radiation and transmit reflected radiation from the security tag.

22. The system of claim 21 wherein the excitation bandpass filter has a rejection ratio of about 10000:1.

23. The system of claim 21 wherein the emission filter has a rejection ratio of about 1000:1.

24. The system of claim 21 wherein the mirror means is a dichroic mirror.

25. The system of claim 24 wherein the dichroic mirror is spatially driven.

26. The system of claim 21 wherein the mirror means is a partially silvered mirror.

27. The system of claim 24 wherein the dichroic mirror has a rejection ratio of between about 5:1 and 100:1.

28. The system of claim 1 wherein the mirror means is a partially silvered mirror.

29. The system of claim 21 wherein the radiation and emission filtering means further includes a focusing lens in the optical path between the source of radiation and the security tag.

30. A system for detecting a luminescent compound comprising:
a radiation emitter;
an emission detector;
a target containing the luminescent compound;
a dichroic mirror positioned between the emission detector and the target positioned to direct radiation from the radiation emitter to the target and an emission from the target to the emission detector; and,
a controller operatively connected to the radiation emitter and the emission detector.

31. The system of claim 30 wherein the dichroic mirror has a rejection ratio of between about 5:1 and 100:1.

32. The system of claim 30 further comprising:
a first bandpass filter positioned between the radiation emitter and the dichroic mirror; and,
a second bandpass filter positioned between the dichroic mirror and the emission detector.

33. The system of claim 32 wherein the first bandpass filter has a rejection ratio of about 10000:1.

34. The system of claim 32 wherein the second bandpass filter has a rejection ratio of about 10000:1.

35. The system of claim 32 wherein the system demonstrates a signal to noise ratio of at least 80 dB.

36. The system of claim 32 further comprising:
a collumnator positioned between the radiation emitter and the first bandpass filter.

37. The system of claim 32 further comprising a columnator between the first bandpass filter and the dichroic mirror.

38. The system of claim 32 further comprising a focusing element between the second bandpass filter and the emission detector.

39. The system of claim 32 further comprising a focusing element between the dichroic mirror and the second bandpass filter.

40. The system of claim 32 further comprising a focusing element between the dichroic mirror and the target.

41. The system of claim 30 wherein the dichroic mirror is spatially driven by a signal from the controller.

42. The system of claim 30 wherein the controller further comprises:
a memory,
a detector control circuit connected to the emission detector; and,
a signal conditioning circuit connected to the emission detector.

43. The system of claim 42 wherein the detector control circuit includes a gain adjustment circuit coupled to the emission detector and controlled by the controller.

44. The system of claim 43 wherein the gain adjustment circuit adjusts the gain in a single direction.

45. The system of claim 43 wherein the detector control circuit includes a means to modify the sensitivity of the emission detector.

46. The system of claim 42 wherein the signaling conditioning circuit includes an anti-aliasing filter.

47. The system of claim 42 wherein the signal conditioning filter includes an amplifier.

48. The system of claim 47 wherein the signal to noise ratio of the amplifier is at least 80 dB.

49. The system of claim 42 wherein the signal conditioning circuit is one of the group of analog to digital converter and digital signal processor.

50. The system of claim 30 wherein the controller includes a communications interface.

51. The system of claim 50 wherein the communications interface includes a visual display means for communicating a test result.

52. The system of claim 50 wherein the communications interface includes a data communication means for storing information in a memory.

53. The system of claim 50 wherein:
the communications interface includes a location determination module;
the controller is programmed to alter data in a memory based on a location signal received from the location determination module; and
the data is related to a spectral signature of the luminescent compound.

54. The system of claim 30 wherein the controller is programmed to:
activate the radiation emitter to emit an excitation;
monitor the emission detector; and,
recognize a spectral signature of the luminescent compound.

55. The system of claim 54 wherein the spectral signature is recognized through a luminescent time constant.

56. The system of claim 54 wherein the spectral signature is recognized according to the equation:
K₁−K₁e^{(1-t′T}^{₁}⁾+a₁
where:
K₁ is an intensity constant related to the luminescent compound;
T₁ is a time constant related to the luminescent compound;
a₁ is a signal level related to excitation; and
5T₁>t>0.

57. The system of claim 54 wherein the spectral signature is recognized according to the equation:
K₁e^{-t′T}^{₂}−a₁
where:
K₁ is an intensity constant related to the luminescent compound;
T₂ is an excitation time constant related to the luminescent compound;
T₁ is a de-excitation time constant related to the luminescent compound;
a₁ is a signal level related to excitation; and
t≅5T₁.

58. The system of claim 54 wherein the spectral signature is a function of:
a₁ is a signal related to excitation;
b₁ is a signal related to excitation;
T₁ is a time constant related to excitation of the luminescent compound;
K₁ is an intensity constant related to the luminescent compound;
c₁ is a final signal rise level;
a₂ is a signal related to de-excitation;
b₂ is a signal related to de-excitation; and
T₂ is a time constant related to de-excitation of the luminescent compound.

59. The system of claim 54 wherein the spectral signature is a function of one of the group of:
a₁ is a signal related to excitation;
b₁ is a signal related to excitation;
T₁ is a time constant related to excitation of the luminescent compound;
K₁ is an intensity constant related to the luminescent compound;
c₁ is a final signal rise level;
a₂ is a signal related to de-excitation;
b₂ is a signal related to de-excitation; and
T₂ is a time constant related to de-excitation of the luminescent compound.

60. The system of claim 30 further comprising a background noise monitoring means, positioned in the optical background of the emission detector for monitoring a background light level.

61. The system of claim 30 further comprising a sensor means, adjacent the target, for identifying the presence of the target.

62. The system of claim 30 further comprising a target positioning means, adjacent the target, for mechanically locating the target with respect to the radiation emitter.

63. A method of determining the authenticity of a luminescent tag comprising:
exciting the luminescent tag;
detecting an emission from the luminescent tag;
measuring a first exponential time constant of the emission during illumination;
de-exciting the luminescent tag;
comparing the first time constant to a predetermined first characteristic time constant; and
indicating authenticity of the luminescent tag if the first time constant matches the predetermined first time constant.

64. The method of claim 63 wherein the luminescent tag is phosphorescent.

65. The method of claim 63 wherein the luminescent tag is fluorescent.

66. The method of claim 63 wherein the luminescent tag is covered by a plurality of blocking layers and further comprising the steps of:
determining a window of transmissivity of the blocking layers;
and the step of illuminating further comprises:
illuminating the luminescent tag within the window;
and the step of detecting further comprises:
detecting the emission within the window.

67. A method of determining the authenticity of a phosphorescent security tag beneath a multilayer package comprising the steps of:
providing a columnated laser within the enclosure aimed at the phosphorescent security tag;
providing a photomultiplier tube within the enclosure positioned to receive an emission from the phosphorescent security tag;
activating the laser;
measuring the voltage of the photomultiplier tube; and, determining a spectral signature of the phosphorescent security tag.

68. The method of claim 67 wherein the step of activating further comprises repeatedly pulsing the laser;
the step of measuring further includes retrieving a predetermined number of samples of an output signal of the photomultiplier tube; and
the step of determining further includes summing the samples to arrive at a parameter set.

69. The method of claim 68 further comprising the step of:
indicating authenticity of the phosphorescent security tag if the parameter set if within a standard deviation of a predefined reference parameter set.

70. The method of claim 67 wherein the spectral signature comprises at least one parameter from the group of:
a₁=a parameter related to an initial voltage of the photomultiplier tube before the phosphorescent security tag is luminated;
b₁=a parameter related to a linear rise in voltage level of the photomultiplier tube during the time the phosphorescent security tag is ruminated;
T₁=a parameter related to an exponential voltage rise time constant during the time that the phosphorescent security tag is luminated;
K₁=a parameter related to a first intensity constant of the voltage level during the time that the phosphorescent security tag is ruminated;
c₁=a parameter related to a final voltage rise level during the time that the phosphorescent security tag is ruminated;
a₂=a parameter related to a final voltage of the photomultiplier tube after the phosphorescent security tag is ruminated;
b₂=a parameter related to a linear fall voltage level of the emission detector after the phosphorescent security tag is luminated;
T₂=a parameter related to an exponential voltage fall constant after the phosphorescent security tag is luminated.

71. The method of claim 67 further comprising the step of setting the gain of the photomultiplier tube before the step of measuring.

72. The method of claim 67 wherein the step of determining comprises:
determining a rise time constant for output voltage of the photomultiplier tube; and,
determining a fall time constant for the output voltage of the photomultiplier tube.

73. The method of claim 67 further comprising the step of
indicating authenticity of the phosphorescent security tag if the rise time constant is within a first predetermined range and the fall time constant is in a second predetermined range.

74. A method of determining the authenticity of a luminescent tag comprising the steps of
exciting the luminescent tag;
detecting an emission from the luminescent tag;
measuring a first exponential time constant of the emission during illumination;
de-exciting the luminescent tag;
measuring a second exponential time constant of the emission during de-excitation;
comparing the first time constant to a predetermined first characteristic time constant;
comparing the second time constant to a predetermined second characteristic time constant; and,
indicating authenticity of the luminescent tag if the first time constant matches the predetermined first time constant and the second time constant matches the predetermined second time constant.

75. The method of claim 74 including the further steps of:
measuring a first amplitude parameter related to excitation of the luminescent tag;
comparing the first amplitude parameter to a predetermined first amplitude parameter; and
indicating authenticity if the first amplitude parameter matches the predetermined first amplitude parameter.

76. A method of determining the authenticity of a luminescent tag comprising the steps of
exciting the luminescent tag by a light pulse;
detecting a waveform related to the emission from the luminescent tag;
measuring a set of parameters from the waveform; and
comparing the set of parameters to a predetermined set of parameters related to the luminescent tag.

77. A method of determining the authenticity of a luminescent tag comprising the steps of:
exciting the luminescent tag by a predetermined number of light pulses;
detecting a predetermined number of waveforms related to the emission from the luminescent tag;
averaging the predetermined number of waveforms to arrive at an analysis waveform;
measuring a set of parameters from the analysis waveform; and
comparing the set of parameters to a predetermined set of parameters related to the luminescent tag.
